(19) United States
(12) Patent Application Publication
(10) Pub. No.: US 2026/0054968 A1
(43) Pub. Date: Feb. 26, 2026

(54) ORIENTATION CORRECTION APPARATUS

(71) Applicant: ISUZU MOTORS LIMITED, Yokohama-shi (JP)

(72) Inventors: Muneyuki OSAWA, Fujisawa-shi (JP); Koya TOKUHARA, Fujisawa-shi (JP); Takahito HOSHI, Fujisawa-shi (JP)

(21) Appl. No.: 19/261,326

(22) Filed: Jul. 7, 2025

(30) Foreign Application Priority Data
Aug. 22, 2024 (JP) 2024-140910

(51) Int. Cl. B66F 7/28; B60L 53/80

(52) U.S. Cl. CPC B66F 7/28; B60L 53/80

(57) ABSTRACT

An orientation correction apparatus includes: a lifting unit that lifts and lowers a wheel receiving portion, which supports the wheel, between a lowered position and a raised position; a stopper that is pivotably supported by the wheel receiving portion, is positioned at a standby position when the wheel receiving portion is in the lowered position, and is positioned at a restricting position for restricting movement of the wheel from the wheel receiving portion when the wheel receiving portion is in the raised position; and a wire mechanism that includes a wire, one end portion of which is connected to the stopper, and causes the stopper to pivot from the standby position to the restricting position by pulling the stopper via the wire when the lifting unit lifts the wheel receiving portion to the raised position.

### CROSS-REFERENCE TO RELATED APPLICATIONS

The present application claims priority to Japanese Patent Application number 2024-140910, filed on Aug. 22, 2024 contents of which are incorporated herein by reference in their entirety.

### BACKGROUND OF THE INVENTION

The present disclosure relates to an orientation correction apparatus for correcting an orientation of a vehicle. Conventionally, in battery replacement systems, devices that correct the orientation of a stationary vehicle have been known. For example, Japanese Unexamined Patent Application Publication No. 2012-6591 discloses a device that corrects the orientation of a vehicle by lifting a conveyor (wheel receiving portion) that supports the wheels of the stationary vehicle.

It is assumed that an external force may act on the wheels supported by the wheel receiving platform. If the wheel receiving platform rises while forces are acting on the wheels, there is a risk that the wheels may shift on the wheel receiving platform and fall off.

### BRIEF SUMMARY OF THE INVENTION

The present disclosure has been made in view of these points, and its object is to prevent the wheels from falling off while a wheel receiving platform rises.

An aspect of the present disclosure provides an orientation correction apparatus that corrects an orientation of a vehicle, the orientation correction apparatus including: a wheel receiving portion that supports a wheel of the vehicle; a lifting unit that lifts and lowers the wheel receiving portion, which supports the wheel, between a lowered position and a raised position; a stopper that is pivotably supported by the wheel receiving portion, is positioned at a standby position when the wheel receiving portion is in the lowered position, and is positioned at a restricting position for restricting movement of the wheel from the wheel receiving portion when the wheel receiving portion is in the raised position; and a wire mechanism that includes a wire, one end portion of which is connected to the stopper, and causes the stopper to pivot from the standby position to the restricting position by pulling the stopper via the wire when the lifting unit lifts the wheel receiving portion to the raised position.

### BRIEF DESCRIPTION OF THE DRAWINGS

FIG. 1 is a schematic diagram illustrating a configuration of a battery replacement system S in which an orientation correction apparatus 1 is installed.

FIG. 2 is a schematic diagram illustrating a state in which the orientation correction apparatus 1 has raised a wheel 110 to a raised position.

FIG. 3 is a perspective view showing the orientation correction apparatus 1 when a wheel receiving portion 10 is positioned at a lowered position.

FIG. 4 is a perspective view showing the orientation correction apparatus 1 when the wheel receiving portion 10 is positioned at the raised position.

FIG. 5 is a schematic view showing a wire mechanism 50.

FIG. 6 is a schematic view showing a state of the wire mechanism 50 when the stopper 30 is positioned at a standby position.

FIG. 7 is a schematic view showing a state of the wire mechanism 50 when the stopper 30 is positioned at a restricting position.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### <Overview of an Orientation Correction Apparatus>

An orientation correction apparatus according to one embodiment corrects the orientation of a stationary vehicle. The orientation of the vehicle is defined in terms of yaw angle, roll angle, and pitch angle, for example. Here, the orientation correction apparatus is installed in a battery replacement system that automatically replaces a battery mounted on a vehicle, but is not limited thereto. The orientation correction apparatus may also be installed in a system that performs vehicle maintenance.

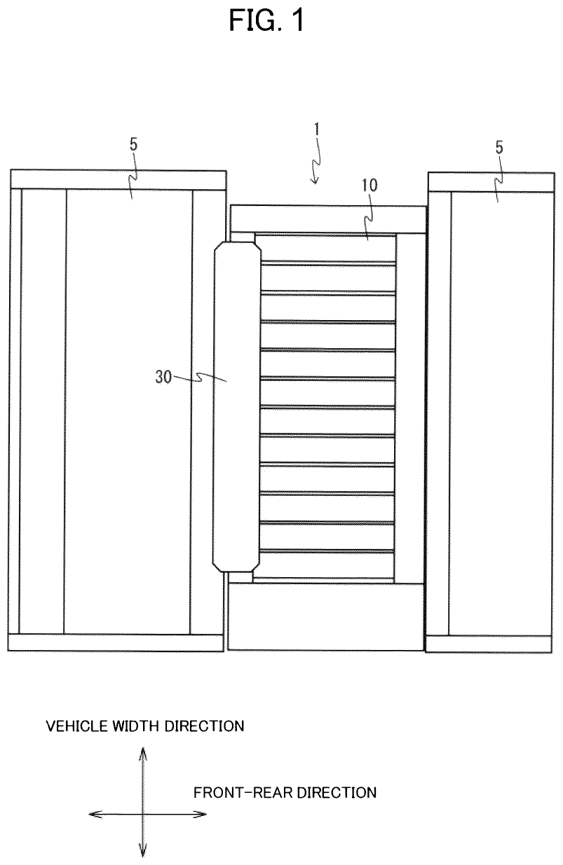

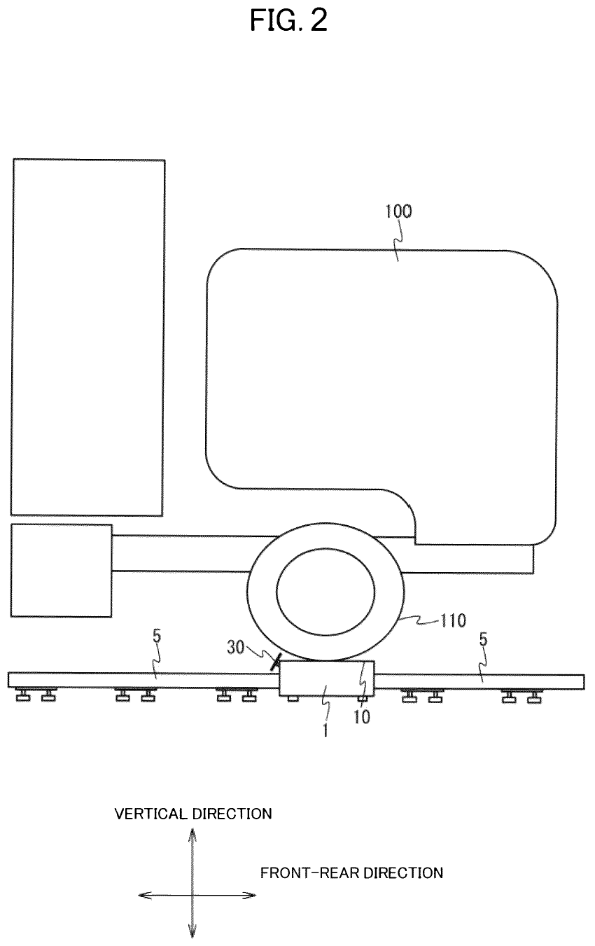

FIG. 1 is a schematic diagram illustrating a configuration of a battery replacement system S in which an orientation correction apparatus 1 is installed. FIG. 2 is a schematic diagram illustrating a state in which the orientation correction apparatus 1 has raised a wheel 110 to a raised position. In FIG. 1, as a matter of convenience, only a part of the battery replacement system S is shown, omitting components such as a device for automatically replacing a battery.

The battery replacement system S includes the orientation correction apparatus 1 and a fixed platform 5. The orientation correction apparatus 1 is provided at a position corresponding to each wheel at a stopping position of a vehicle 100. In FIG. 1, only the orientation correction apparatus 1 corresponding to the right front wheel of the vehicle 100 is shown, but in actuality, a plurality of (specifically, four) orientation correction apparatuses 1 are installed.

The fixed platform 5 is a platform fixed on a path along which the vehicle 100 proceeds. The fixed platform 5 forms a path along which the wheels 110 of the vehicle 100 pass. The fixed platform 5 is disposed in front of and behind the orientation correction apparatus 1.

The orientation correction apparatus 1 corrects the orientation of the vehicle 100 before its battery is replaced. That is, the orientation correction apparatus 1 corrects the orientation of the stationary vehicle 100 in order to make it easier for the replacement device to replace the battery. For example, the orientation correction apparatus 1 corrects the orientation of the vehicle 100 by moving the wheels 110 of the stationary vehicle 100 in both the vehicle width direction and the vertical direction.

The orientation correction apparatus 1 includes a wheel receiving portion 10 that supports the wheels 110. For example, in order to replace the battery, as shown in FIG. 2, the orientation correction apparatus 1 lifts the wheel receiving portion 10 supporting the wheel 110. At this time, when an external force acts on the wheel supported by the wheel receiving portion 10, the wheel may shift on the wheel receiving portion 10.

On the other hand, the orientation correction apparatus 1 of the present embodiment includes a stopper 30 that restricts movement of the wheel when the wheel receiving portion 10 is raised, the details of which will be described later. The stopper 30, here, restricts rearward movement of the wheel to keep the wheel 110 on the wheel receiving portion 10. In particular, since the stopper 30 pivots in conjunction with the movement of the wheel receiving portion 10 and is positioned at a restricting position, it is possible to prevent the wheel 110 from falling from the wheel receiving portion 10 while the wheel receiving portion 10 rises.

### <Detailed Configuration of the Orientation Correction Apparatus>

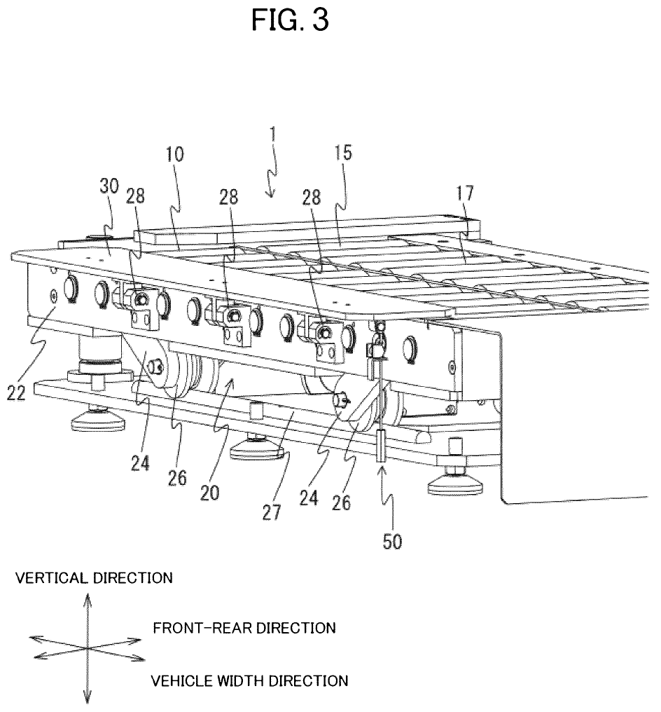

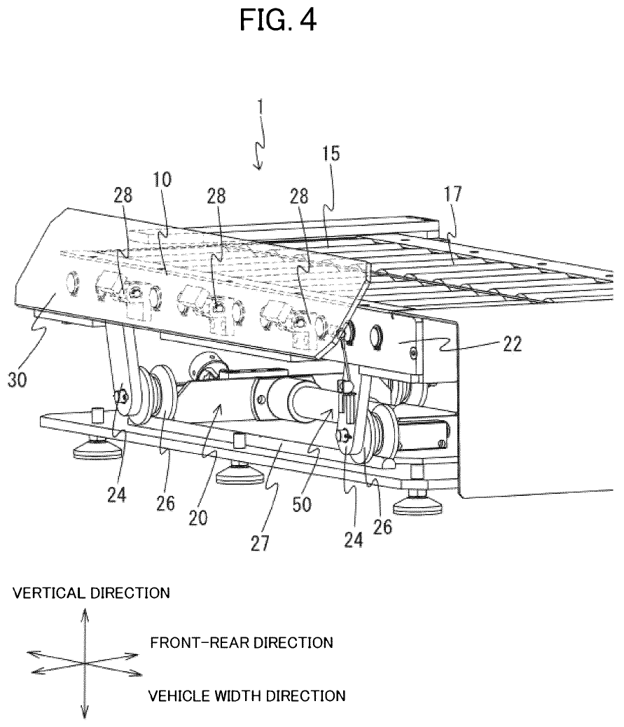

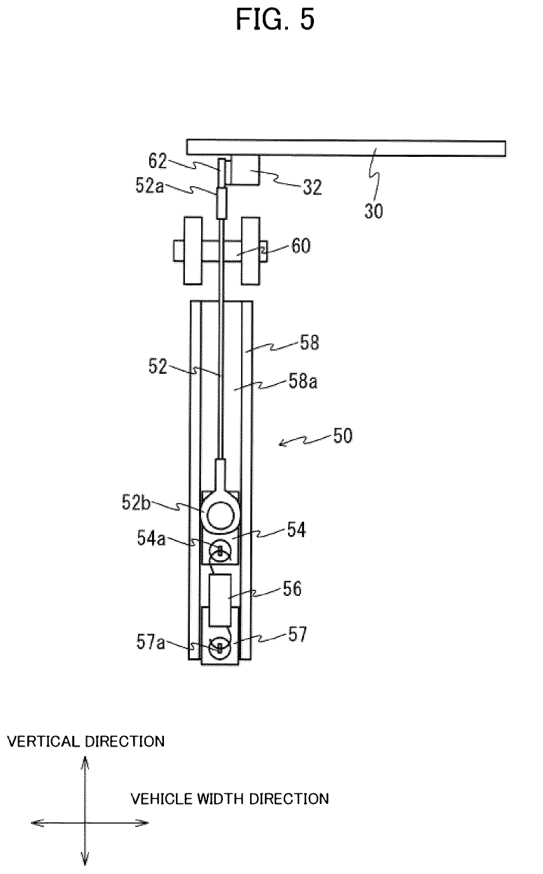

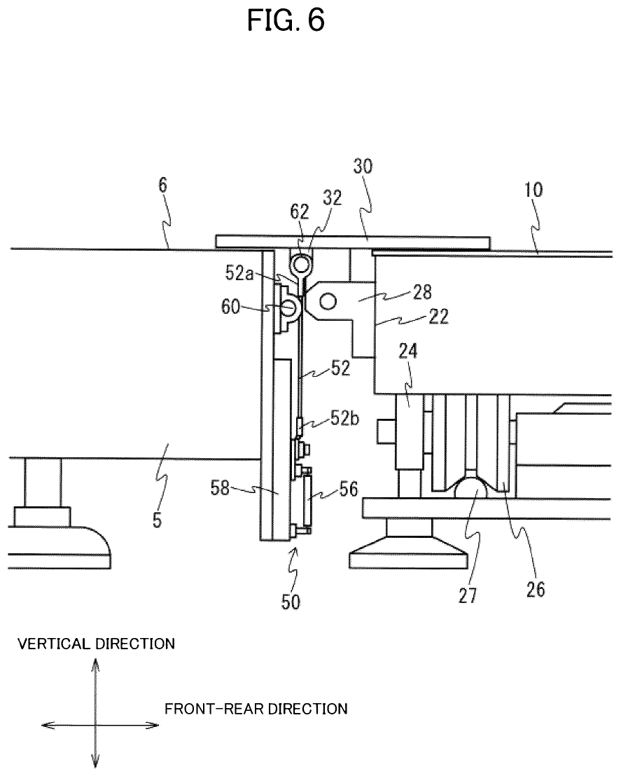

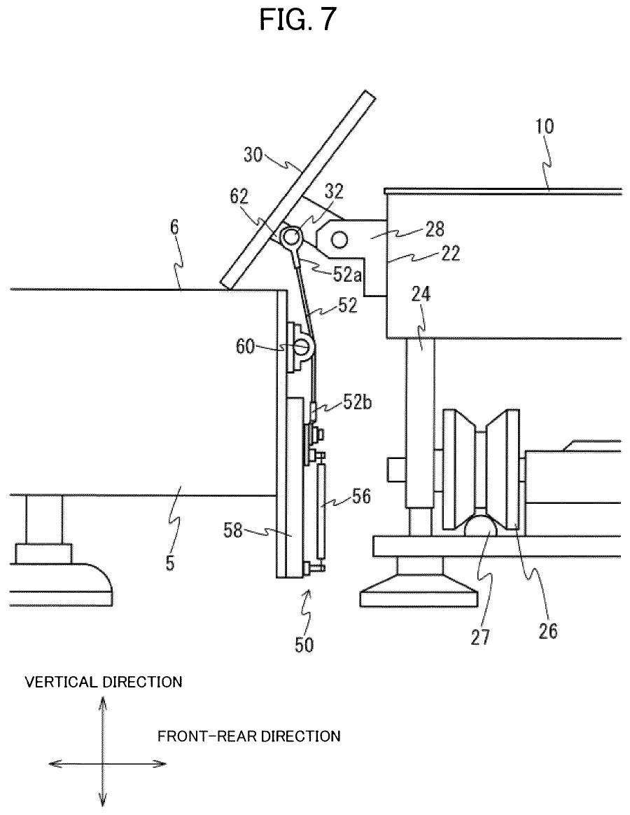

A detailed configuration of the orientation correction apparatus 1 will be described with reference to FIGS. 3 to 7. FIG. 3 is a perspective view showing the orientation correction apparatus 1 when the wheel receiving portion 10 is positioned at a lowered position. FIG. 4 is a perspective view showing the orientation correction apparatus 1 when the wheel receiving portion 10 is positioned at a raised position. FIG. 5 is a schematic view showing a wire mechanism 50. FIG. 6 is a schematic view showing a state of the wire mechanism 50 when the stopper 30 is positioned at a standby position. FIG. 7 is a schematic view showing a state of the wire mechanism 50 when the stopper 30 is positioned at a restricting position. In FIG. 4, the stopper 30 is made transparent for convenience of explanation.

As described above, the orientation correction apparatus 1 is provided at a position corresponding to each wheel 110 of the vehicle 100, but the configuration of each orientation correction apparatus 1 is the same. Therefore, hereinafter, the configuration of the orientation correction apparatus 1 provided at the position corresponding to the wheel 110 (here, the right front wheel) on the front side of the vehicle 100 will be described.

It is assumed here that the vehicle 100 is a truck. When the vehicle 100 is a truck, the vehicle height of the vehicle 100's front portion tends to be low, and therefore, in many cases, the wheel receiving portion 10 for the wheel 110 on the front side of the vehicle 100 is raised. As a result, by providing the stopper 30, the effect of preventing the wheel 110 from falling from the wheel receiving portion 10 is more effectively achieved.

As shown in FIG. 3, the orientation correction apparatus 1 includes the wheel receiving portion 10, a conveyor unit 15, a lifting mechanism 20, the stopper 30, and a wire mechanism 50.

The wheel receiving portion 10 supports one wheel 110 of the vehicle 100 positioned at the stopping position. Here, the wheel receiving portion 10 supports the right front wheel 110 of the truck. The length of the wheel receiving portion 10 in the front-rear direction is smaller than the diameter of the wheel 110. In this case, while the wheel receiving portion 10 can be made more compact, the risk of the wheel 110 falling from the wheel receiving portion 10 increases. However, by providing the stopper 30, the effect of preventing the wheel 110 from falling from the wheel receiving portion 10 while the wheel receiving portion 10 is rising is more effectively achieved. The wheel receiving portion 10 moves up and down between the lowered position shown in FIG. 3 and the raised position shown in FIG. 4. When the wheel 110 of the vehicle 100 moves on the fixed platform 5 (FIG. 1), the wheel receiving portion 10 is positioned at the lowered position. When the orientation of the wheel 110 is corrected, the wheel receiving portion 10 moves from the lowered position to the raised position.

The conveyor unit 15 is provided on the upper surface of the wheel receiving portion 10, and has a function of moving the wheel 110 supported by the wheel receiving portion 10 in the vehicle width direction. The conveyor unit 15 includes a plurality of rollers 17 provided at predetermined intervals in the vehicle width direction. The wheels 110 are in contact with some of the rollers 17 among the plurality of rollers 17. The wheel 110 can be moved in the vehicle width direction by the rotation of the rollers 17, which are in contact with the wheel 110. The wheel receiving portion 10 moves up and down between the lowered position and the raised position in a state where the wheel 110 is in contact with the rollers 17.

The lifting mechanism 20 moves the wheel receiving portion 10 up and down. The lifting mechanism 20 lifts and lowers the wheel receiving portion 10 supporting the wheel 110 between the lowered position and the raised position. The lifting mechanism 20 has a motor as a power source, and moves the wheel receiving portion 10 up and down using the motor's power. As shown in FIG. 3, the lifting mechanism 20 includes a lifting unit 22, a link member 24, and a wheel unit 26.

The lifting unit 22 is integrated with the wheel receiving portion 10 (in other words, the lifting unit 22 forms part of the wheel receiving portion 10), and lifts and lowers the wheel receiving portion 10. The lifting unit 22 is provided at a position facing the fixed platform 5. Specifically, the lifting unit 22 is located on a side surface (a surface facing the fixed platform 5) of the wheel receiving portion 10. The lifting unit 22 is provided with a plurality of pivot support units 28.

The pivot support units 28 pivotably support the stopper 30. The pivot support units 28 support the lower surface of the stopper 30. The plurality of pivot support units 28 are provided at predetermined intervals in the longitudinal direction of the lifting unit 22. Therefore, the pivot support units 28 pivotably support the stopper 30 relative to the lifting unit 22.

The link member 24 connects the lifting unit 22 and the wheel unit 26. One end portion of the link member 24 in the longitudinal direction is connected to the lifting unit 22, and the other end portion of the link member 24 in the longitudinal direction is connected to the wheel unit 26. By having the link member 24 pivot, the lifting unit 22 is caused to move up and down.

The wheel unit 26 rolls on a guide unit 27 provided parallel to the vehicle width direction. For example, the wheel unit 26 rolls on the guide unit 27 by receiving power from the motor that moves the lifting unit 22 up and down. The guide unit 27 is formed in a rod shape. As the wheel unit 26 rolls, it causes the link member 24 to pivot. When the wheel unit 26 rolls toward both longitudinal ends of the guide unit 27 (see FIG. 4), the link member 24 pivots in a manner that raises the lifting unit 22. Conversely, when the wheel unit 26 rolls toward the longitudinal center of the guide unit 27 (see FIG. 3), the link member 24 pivots in a manner that lowers the lifting unit 22.

The stopper 30 restricts movement of the wheel 110 from the wheel receiving portion 10. The stopper 30 is a plate member. The stopper 30 is provided so that its longitudinal direction is parallel to the vehicle width direction. The stopper 30 restricts the wheel 110 from falling from the wheel receiving portion 10 when the wheel receiving portion 10 is positioned at the raised position. Here, the stopper 30 is positioned behind the wheel 110 in the front-rear direction of the vehicle 100 (see FIG. 2), and restricts the wheel 110 from falling from the wheel receiving portion 10 rearward. When the vehicle 100 is a truck, the likelihood of the wheel 110 falling rearward increases as the lifting unit 22 rises. Therefore, the stopper 30 is provided on the rear side of the wheel receiving portion 10 in the front-rear direction.

The stopper 30 is provided such that its position can be changed. When the wheel receiving portion 10 is in the raised position, as shown in FIG. 4, the stopper 30 is positioned at the restricting position for restricting the movement of the wheel 110 from the wheel receiving portion 10. On the other hand, when the wheel receiving portion 10 is in the lowered position, as shown in FIG. 3, the stopper 30 is positioned at the standby position. When the stopper 30 is positioned at the standby position, the stopper 30 does not restrict the movement of the wheel 110. It should be noted that the stopper 30 is parallel to the upper surface of the wheel receiving portion 10 when it is in the standby position.

The stopper 30 moves between the standby position and the restricting position. The stopper 30 is pivotably supported by the wheel receiving portion 10, and pivots between the standby position and the restricting position in conjunction with the movement of the wheel receiving portion 10. For example, the stopper 30 positioned at the standby position moves toward the restricting position when the wheel receiving portion 10 moves from the lowered position to the raised position. In this manner, the position and orientation of the stopper 30 change in accordance with the movement of the wheel receiving portion 10.

The stopper 30 is positioned so as to intersect with the lifting direction (vertical direction) when it is positioned at the restricting position. Specifically, the stopper 30 positioned at the restricting position is inclined with respect to the upper surface of the wheel receiving portion 10. The angle between the stopper 30, which is positioned at the restricting position, and the upper surface of the wheel receiving portion 10 is smaller than 90 degrees (see FIG. 7). In this case, even if a force applied by the wheel 110 to the plate-shaped stopper 30 increases, the stopper 30 does not deform and can more effectively support the wheel 110.

When positioned at the restricting position, the stopper 30 is in contact with the upper surface 6 of the fixed platform 5 (see FIG. 7). This contact restricts the pivoting of the stopper 30, thereby allowing the stopper 30 to be held at the restricting position. Furthermore, since the stopper 30 is in contact with the upper surface 6 of the fixed platform 5, a reaction force acts on the stopper 30 from the upper surface 6. Therefore, when the wheel receiving portion 10 moves from the raised position to the lowered position, the stopper 30 receives the reaction force from the upper surface 6 of the fixed platform 5 and pivots from the restricting position to the standby position. As a result, lowering the wheel receiving portion 10 to the lowered position facilitates the pivoting of the stopper 30 from the restricting position to the standby position.

The stopper 30 covers the gap between the wheel receiving portion 10 and the fixed platform 5 (see FIG. 6) when the stopper 30 is positioned at the standby position. When the stopper 30 is positioned at the standby position, the lower surface of the stopper 30 is in contact with the upper surface of the wheel receiving portion 10 and the upper surface of the fixed platform 5. The upper surface of the stopper 30 is positioned above the upper surface of the wheel receiving portion 10 by an amount corresponding to the thickness of the stopper 30. Therefore, the wheel 110 passes over the stopper 30 in the standby position and is positioned on the wheel receiving portion 10. In the absence of the stopper 30, there is a risk that an impact may act on the wheel 110 when the wheel 110 passes through the gap between the fixed platform 5 and the wheel receiving portion 10. However, by covering the gap, the stopper 30 enables the wheel 110 to move smoothly.

The wire mechanism 50 is a mechanism for pivoting the stopper 30 when the wheel receiving portion 10 moves up and down. The wire mechanism 50 includes a wire 52, one end portion 52a of which is connected to the stopper 30. When the lifting unit 22 lifts the wheel receiving portion 10 to the raised position, the wire mechanism 50 causes the stopper 30 to pivot from the standby position to the restricting position by pulling the stopper 30 via the wire 52. As shown in FIG. 3, the wire mechanism 50 is provided on one longitudinal end of the stopper 30. However, the present disclosure is not limited thereto, and the wire mechanism 50 may instead be provided on the other longitudinal end of the stopper 30. The wire mechanism 50 may be provided at the longitudinal center of the stopper 30.

A detailed configuration of the wire mechanism 50 will be described with reference to FIGS. 5 to 7. As illustrated in FIG. 5, the wire mechanism 50 includes the wire 52, a slider 54, a holding portion 56, a guide unit 58, a support unit 60, and a coupling portion 62.

Here, the wire 52 is made of metal and is provided so as to connect the stopper 30 and the fixed platform 5. Specifically, one end portion 52a of the wire 52 is connected to the stopper 30, and the other end portion 52b of the wire 52 is connected to the fixed platform 5 (specifically, the holding portion 56). The wire 52 is provided along the vertical direction. The wire 52 is movable up and down along the guide unit 58 when the wheel receiving portion 10 moves up and down.

The wire 52 pulls the stopper 30 when the wheel receiving portion 10 moves from the lowered position to the raised position. Specifically, by having the wire 52 pull the stopper 30 while bending as shown in FIG. 7, the stopper 30 pivots from the standby position to the restricting position. In other words, the stopper 30 pivots from the standby position to the restricting position due to the tension of the wire 52.

As shown in FIG. 5, the slider 54 is coupled to the other end portion 52b of the wire 52. The slider 54 is movable along the guide unit 58. When the slider 54 moves, the position of the other end portion 52b of the wire 52 also moves. The other end portion 52b is positioned at a first position shown in FIG. 6 when the wheel receiving portion 10 is positioned at the lowered position, and is positioned at a second position shown in FIG. 7 when the wheel receiving portion 10 is positioned at the raised position.

The holding portion 56 is coupled to the other end portion 52b of the wire 52 via the slider 54. The holding portion 56 holds the other end portion 52b of the wire 52 at a holding position, in conjunction with the lifting of the wheel receiving portion 10 to the raised position. Specifically, the holding portion 56 holds the other end portion 52b at a holding position while the wheel receiving portion 10 is being raised to the raised position. The holding portion 56 holds the other end portion 52b at the holding position even during the rising of the wheel receiving portion 10 toward the raised position. Furthermore, the holding portion 56 holds the other end portion 52b at the holding position while the wheel receiving portion 10 is positioned at the raised position. That is, the holding position of the other end portion 52b is the second position. Therefore, the one end portion 52a of the wire 52 pulls the stopper 30 in a state where the other end portion 52b is held at the holding position, and causes the stopper 30 to pivot to the restricting position.

Here, the holding portion 56 is a spring member that pulls the other end portion 52b downward via the slider 54. The spring member is specifically a tension spring. The holding portion 56 holds the other end portion 52b at the holding position due to an elastic force of the tension spring. One end of the spring member is connected to a column portion 54a of the slider 54, and the other end of the spring member is connected to a column portion 57a of a fixed portion 57. The slider 54 is pulled by the elastic force of the contracting spring member. The slider 54 rises against this elastic force.

As shown in FIG. 6, the guide unit 58 is provided on the fixed platform 5. The guide unit 58 is provided parallel to the vertical direction and guides the vertical movement of the slider 54. The guide unit 58 includes a recess 58a extending in the vertical direction, and the slider 54 moves within the recess 58a. For example, the guide unit 58 guides the rising of the other end portion 52b from the first position to the second position (holding position) when the wheel receiving portion 10 moves to the raised position. Similarly, the guide unit 58 guides the lowering of the other end portion 52b from the second position to the first position when the wheel receiving portion 10 moves to the lowered position.

As shown in FIG. 6, the support unit 60 is provided above the guide unit 58 in the fixed platform 5 so as to be in contact with the wire 52. Here, the support unit 60 is a shaft, and the wire 52 is in contact with an outer peripheral surface of the shaft. For example, the support unit 60 contacts the curved wire 52 when the other end portion 52b of the wire 52 is positioned at the holding position. As a result, the support unit 60 can place the wire 52 in a tensioned state, thereby facilitating the pulling of the stopper 30 by the wire 52 and making it possible that the stopper 30 can pivot smoothly.

The coupling portion 62 freely rotatably couples the one end portion 52a of the wire 52 to the stopper 30. The coupling portion 62 is fixed to the one end portion 52a. The coupling portion 62 is rotatably coupled to, for example, a coupling portion 32 provided on the lower surface of the stopper 30. Therefore, the coupling portion 62 and the one end portion 52a are rotatable when the stopper 30 pivots. In this way, when the wire 52 bends in conjunction with the pivoting of the stopper 30, the one end portion 52a of the wire 52 rotates relative to the stopper 30 via the coupling portion 62, thereby preventing twisting at the one end portion 52a. As a result, the wire 52 is maintained in the tensioned state during the pivoting of the stopper 30, allowing the one end portion 52a to reliably pull the stopper 30.

### <Modification>

Although the holding portion 56 is the spring member in the above description, the present embodiment is not limited to this. For example, the holding portion 56 may be a weight coupled to the other end portion 52b located vertically below the one end portion 52a of the wire 52. In this case, since the weight pulls the other end portion 52b downward, the other end portion 52b of the wire 52 can be held at the holding position with a simple configuration.

Furthermore, in the above description, the stopper 30 restricts the rearward movement of the wheel 110 on the wheel receiving portion 10, but the present embodiment is not limited thereto. For example, the stopper 30 may be provided at a position that restricts forward movement of the wheel 110 on the wheel receiving portion 10.

Furthermore, in the above description, the orientation correction apparatus 1 provided at the position corresponding to a front wheel of the vehicle 100 includes the stopper 30, but is not limited thereto. For example, the orientation correction apparatus 1 provided at a position corresponding to a rear wheel of the vehicle 100 may include the stopper 30. Each of the orientation correction apparatuses 1 provided at positions corresponding to the wheels of the vehicle 100 may include the stopper 30.

### Effects of Embodiment

The orientation correction apparatus 1 of the above-described embodiment includes the lifting unit 22 that lifts and lowers the wheel receiving portion 10 that supports the wheel 110, and the stopper 30 that is pivotably supported by the wheel receiving portion 10 between the standby position and the restricting position for restricting the movement of the wheel 110 from the wheel receiving portion 10. Furthermore, the orientation correction apparatus 1 includes the wire mechanism 50 having the wire 52, one end portion of which is connected to the stopper 30, and the wire mechanism 50 causes the stopper 30 to pivot from the standby position to the restricting position by having the wire 52 pull the stopper 30 when the lifting unit 22 lifts the wheel receiving portion 10 to the raised position. In this way, when the wheel receiving portion 10 moves to the raised position, the wire 52 of the wire mechanism 50 pulls the stopper 30, causing the stopper 30 to pivot to the restricting position. Therefore, if the wheel 110 is subjected to an external force and thereby tends to move while the wheel receiving portion 10 is rising, the wheel 110 comes into contact with the stopper 30, thereby preventing the wheel 110 from falling from the wheel receiving portion 10.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An orientation correction apparatus that corrects an orientation of a vehicle, the orientation correction apparatus comprising:
a wheel receiving portion that supports a wheel of the vehicle;
a lifting unit that lifts and lowers the wheel receiving portion, which supports the wheel, between a lowered position and a raised position;
a stopper that is pivotably supported by the wheel receiving portion, is positioned at a standby position when the wheel receiving portion is in the lowered position, and is positioned at a restricting position for restricting movement of the wheel from the wheel receiving portion when the wheel receiving portion is in the raised position; and
a wire mechanism that includes a wire, one end portion of which is connected to the stopper, and causes the stopper to pivot from the standby position to the restricting position by pulling the stopper via the wire when the lifting unit lifts the wheel receiving portion to the raised position.

2. The orientation correction apparatus according to claim 1, further comprising:
a fixed platform that is provided at a position facing the lifting unit and to which the other end portion of the wire is connected, wherein the wire mechanism causes the stopper to pivot to the restricting position where the stopper contacts an upper surface of the fixed platform, and
the stopper receives a reaction force from the upper surface and pivots from the restricting position to the standby position when the wheel receiving portion moves from the raised position to the lowered position.

3. The orientation correction apparatus according to claim 1, further comprising:
a fixed platform that is provided at a position facing the lifting unit and to which the other end portion of the wire is connected, wherein the wire mechanism further includes:
a holding portion that holds the other end portion of the wire at a holding position, in conjunction with the lifting of the wheel receiving portion to the raised position, and in a state where the other end portion of the wire is held at the holding position, the one end portion pulls the stopper.

4. The orientation correction apparatus according to claim 3, wherein the holding portion is a spring member that is connected to the other end portion of the wire and pulls the other end portion downward.

5. The orientation correction apparatus according to claim 3, wherein the wire is provided along a vertical direction, and
the holding portion is a weight coupled to the other end portion located vertically below the one end portion of the wire.

6. The orientation correction apparatus according to claim 3, wherein the wire mechanism further includes:
a guide unit that guides the rising of the other end portion to the holding position when the wheel receiving portion moves to the raised position.

7. The orientation correction apparatus according to claim 3, wherein by having the wire pull the stopper while bending, the stopper pivots from the standby position to the restricting position, and
the wire mechanism further includes:
a support unit that is provided on the fixed platform and is in contact with the curved wire.

8. The orientation correction apparatus according to claim 3, wherein the wire mechanism includes a coupling portion that freely rotatably couples the one end portion of the wire to the stopper, and
when the wire bends in conjunction with the pivoting of the stopper from the standby position to the restricting position, the one end portion rotates relative to the stopper via the coupling portion.

9. The orientation correction apparatus according to claim 1, wherein the stopper is a plate member, and
in a state where the stopper is positioned at the standby position, a lower surface of the stopper is in contact with an upper surface of the wheel receiving portion.

10. The orientation correction apparatus according to claim 1, wherein the stopper is a plate member, and
the stopper is parallel to an upper surface of the wheel receiving portion when positioned at the standby position, and is inclined with respect to the upper surface of the wheel receiving portion when positioned at the restricting position.

11. The orientation correction apparatus according to claim 1, wherein the vehicle is a truck, and
the wheel receiving portion supports a front wheel of the truck.
